(19) United States
(12) Patent Application Publication
(10) Pub. No.: US 2005/0152139 A1
(43) Pub. Date: Jul. 14, 2005

(54) Process for making lighted fiberglass panels

(76) Inventors: David Shawn Loving, Ocean Springs, MS (US); Gregory Friedlander, Mobile, AL (US)

Correspondence Address: Gregory M. Friedlander;Gregory M. Friedlander & Associates, P.C., 11 South Florida Street, Mobile, AL, 36606-1934, US

(21) Appl. No.: 11/061,972

(22) Filed: Feb. 16, 2005

Related U.S. Application Data
(63) Continuation-in-part of application No. 10/207,684, filed on Jul. 26, 2002.
(63) Continuation-in-part of application No. 09/338,164, filed on Jun. 22, 1999, now Pat. No. 6,203,749.
(63) Continuation-in-part of application No. 08/734,586, filed on Oct. 22, 1996, now abandoned.
(63) Continuation-in-part of application No. 09/372,436, filed on Aug. 11, 1999, now Pat. No. 6,508,974.

(51) Int. Cl. F21V 21/00

(52) U.S. Cl. 362/227; 40/541; 428/76; 264/258

(57) ABSTRACT

A method of lighting a panel made of resin absorbing material is taught along with a lay up for carrying out the method. The method involves fixing a light generating means, preferably fiber optics, within a layer of the lay up which may be resin absorbing or non resin absorbing, rigid, flexible or semi-rigid in different embodiments. The method involves flowing resin from an inlet opening into a sealed mold which may be as little as a shaping layer and a vacuum bag. The lay up is comprised of at least one top layer of absorbent or reinforcing material which defines a passage or hole from the inlet opening to a non-absorbent layer which non-absorbent layer lies above at least one bottom layer of reinforcing material. At least one of these layers contains the light means, which are preferably fiber optic fibers. The fibers where necessary are protected in a tube prior to filling the lay up with resin at the point of entry into the mold to protect them.

### PRIORITY CLAIM STATEMENT

Priority Application: This is a Continuation in Part of:

Application Numbers and Filing Dates: Ser. No. 09/338,164 Filed Jun. 22, 1999 now U.S. Pat. No. 6,508,974 issued Jan. 21, 2003; Ser. No. 08/734,586 Filed Oct. 22, 1996; 60/019,314 Filed Jun. 7, 1996; 60/012,120 Filed Feb. 15, 1996; Ser. No. 09/372,436 Filed Aug. 11, 1999 now U.S. Pat. No. 6,203,749 issued Mar. 20, 2001 and application Ser. No. 10/207,684 Filed Jul. 26, 2002.

### FIELD OF THE INVENTION

The invention relates to fiberglass molding processes. More particularly, the invention relates to vacuum assisted resin impregnation of fiber reinforced lay-ups in reinforcing mold designs. More particularly the invention involves lighting resin or molded panels.

### PRIOR ART

A separate listing of prior art has been filed in conjunction with this application.

### GENERAL DESCRIPTION OF THE PREFERRED EMBODIMENT

A method of lighting a panel made of resin absorbing material is taught along with a lay up for carrying out the method. The method involves fixing a light generating means, preferably fiber optics, within a layer of the lay up which may be resin absorbing or non resin absorbing, rigid, flexible or semi-rigid in different embodiments. The method involves flowing resin from an inlet opening into a sealed mold which may be as little as a shaping layer and a vacuum bag. The lay up is comprised of at least one top layer of absorbent or reinforcing material which defines a passage or hole from the inlet opening to a non-absorbent layer which non-absorbent layer lies above at least one bottom layer of reinforcing material. At least one of these layers contains the light means, which are preferably fiber optic fibers. The fibers where necessary are protected in a tube prior to filling the lay up with resin at the point of entry into the mold to protect them.

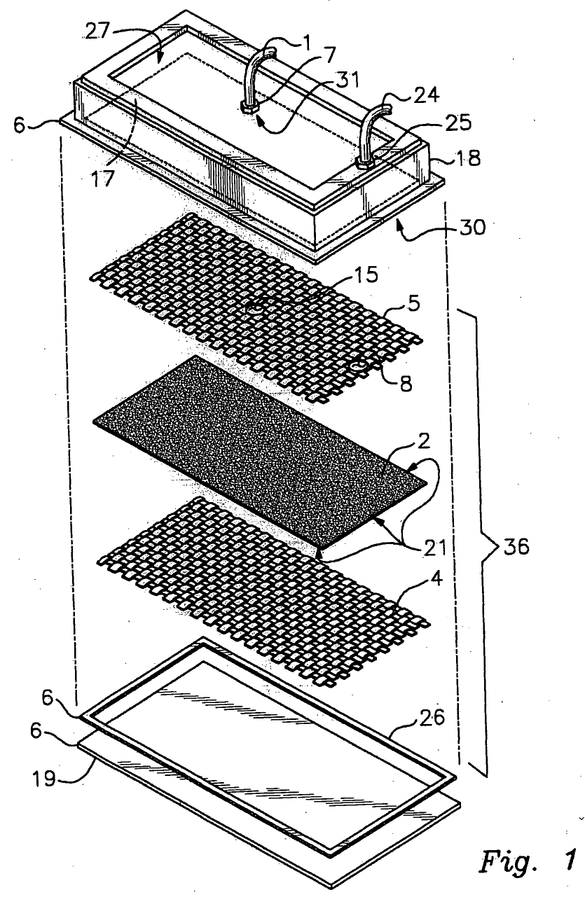

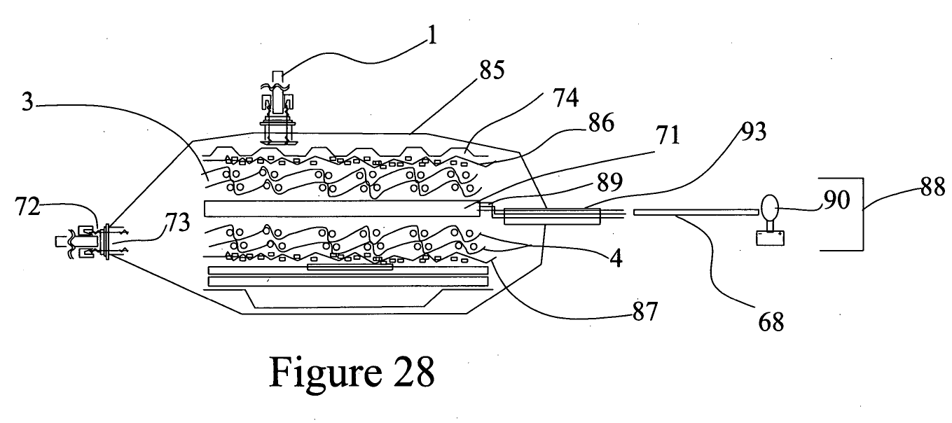

As can best be seen by reference to FIG. 28 of the invention, a preferably non-absorbent porous holding layer 71 is positioned between a top fiberglass resin absorbent layer 3 and a bottom fiberglass resin absorbent layer 4. The non-absorbent layer is woven to provide a weave which defines passages for the resin to travel. Where now absorbent layer 71 is nearly identified to layer 2 as shown in FIG. 1. This lay up 36 comprised of layers 71, 4 and 5 communicates with a resin source (not shown, but this may be nothing more than a bucket containing resin) by way of tube 1. The tube 1 enters the top of the mold through a vacuum bag 85. An entry comprising an opening or channel 15 (FIG. 1) defined in the top absorbent layer 5 is located directly below this tube 1. This channel 5 is sufficiently large to allow the resin to reach the non-absorbent layer 2 or layer 71 in FIG. 28) at a desired rate. This channel 15 also allows the resin to reach the porous non-absorbing layer 2 without a sufficient amount of dissolved absorbing material which would clog up the pores in the porous non-absorbing layer 2.

The threads as shown in the Figure run in at least two different directions and overlap as shown in order to provide a weave of the type typical.

The length of the threads, whether they run the entire length of the lay up or not is largely optional, but in a weaving of the thread is useful in order to maintain the shape of the lay up and in order to provide a threading with spaces which spaces are sufficiently wide to receive and shape the direction of the fibers of the fiber optic panels used.

There is a control means which controls the color of light either electronically or using a mechanical panel in order to allow one or more fibers in the fiber optics to carry specific colors of light or specific wave lengths of light so that the panel can provide a display which provides a greater variety of light options much as a television screen does.

In the preferred embodiment, the layer 71 is a weave of non-absorbent fibers so that the spaces between the weaves provides the channels. Some of these channels hold and guide fiber optics 89. Examples of solid cores, as opposed to woven cores, includes wood having grooves, channels or holes throughout the surface and foam having grooves, channels or holes throughout the surface; metal woven from fibers or having grooves, channels or holes throughout the surface. Examples of woven cores include plastic woven fibers or woven or knitted non-absorbent monofilament, greenhouse shading, etc. Those may be used with the weave for different purposes. The channels 3 within the weaves work best when they are usually between 0.0075 inches and 0.60 inches.

In most applications, the top opening or passage 15 would be at least 25% of the diameter of the input opening 7 through which the resin enters. Generally, the size of this passage may still continue to function with some success having a width of 1/16th inch to 3 inches and a depth of 1/16th to 3 inches with very small molds. The size and depth of the hole will vary with the diameter of the mold and the amount of pressure used to draw the resin into the mold.

The invention is further defined as comprising a resin source for supplying resin to at least three layers so defined. This resin source is typically defined in terms of a tube 1 supplying resin into a relatively air-tight mold. The resin is drawn into the mold when a vacuum is applied to the mold. Because of the unique features of this technique and lay-up, it may also be defined in terms of injecting resin under a pressure into a mold without a vacuum since the current invention may be practiced with the resin under pressure because of the benefits associated with the internal distribution medium with unrestricted access to the resin source. A drain would still be necessary to bleed air out of the mold as the resin fills the mold. With large molds, such as ship hulls, pressure may be necessary since it may be impractical to put the entire mold under a sufficient vacuum.

The mold 6 (shown in FIG. 1) has a top 18 which defines an input opening 7 substantially or approximately over the passage 15 in the absorbing layer. This passage 15 may be an opening in the reinforcing top layer 5 or it may be filled with non-absorbing mesh. In addition to the general parameters set forth above for the passage 15 defined by the top layer 5 of absorbing material (that it be at least 1/16th inch or 25% ofthe size of the opening through which the fiberglass resin enters the mold). The passage 15 can also be more narrowly defined as being at least ½ the size of the opening 7 or ⅓ of an inch in diameter to get the full benefit of the opening. For normal conditions, that is molds using standard resin, of normal size, temperature and pressure, these limitations are more suitable.

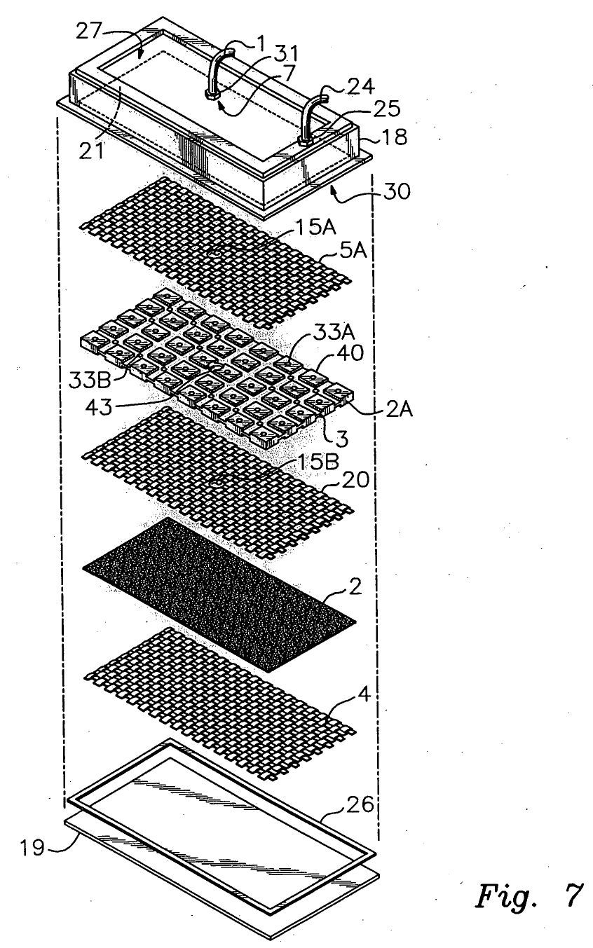

Similarly, there maybe more than one passage 15 within the scope of the invention set forth herein where larger molds are utilized allowing for the size of the passages 15a-15b to be smaller as shown in FIG. 7. Though only two passages 15 are shown in FIG. 7, it is obvious that the number may vary considerably. For example, if a boat hull was constructed using this technique, there could be several hundred passages 15, all receiving resin under pressure and/or all subjected to a common vacuum.

Substantially smaller passages 15 in the absorbing top layer 5 might result in a portion of the absorbing material fouling the passage 15 and affecting resin flow throughout the non-absorbent layer 5. Also material from the top layer might flow into the non-absorbent layer 2 clogging the channels 3 in the non-absorbent layer 2 if there is no passage 15. The function of the passage 15, is therefore seen to be (1) preventing the inflow of absorbing material into the non-absorbent layer 2 and (2) to prevent the expanding absorbing material from clogging the flow of resin through the passage 15.

The non-absorbent porous layer need only be substantially non-absorbing, since under some circumstances, the absorption of fiberglass could have a desirable effect as long as the overall function of the channels 3 was not affected. This might be possible, for example, if the mesh was coarse enough that the swollen fibers did not clog the mesh. It is also clear from this discussion that having a weave of non-absorbing material having a series of passages, at least one of which was 1/16th inch would also function. The main limitation in the size of the passage 15 is that when the hole exceeds a certain size, the beneficial effect of the reinforcing top layer 5 is missing at the inlet cite. By having multiple inlet openings 7 and multiple passages 15, this problem may be avoided.

The non-absorbing layer 2 may be defined as being substantially non-absorbing. Substantially non-absorbing simply means that it does not degrade or swell with the absorption of the fiberglass resin sufficiently to substantially impair the flow of resin through the channels defined by the non-absorbing layer 2. Substantially impaired flow means that the flow would be so impaired so that the process would improperly (insufficiently or irregularly) fill the lay-up 36 with resin.

Other additional limitations which are important to more narrow versions of the invention includes the limitations on the diameter of the opening defined and use of a the core between layers of non-enforcing and reinforcing fiber so that the core becomes a part of the mold. Various modifications of the core to make this construction stronger are also taught.

It is therefore one purpose of the invention is to teach and claim a light structure embedded within a clear fiberglass resin.

A further purpose is to teach a method of manufacturing utilizing a fiberglass resin whereby a sufficient fiberglass content may be provided within a lighted structure so that the lights are both protected and visible so that the finished resin continuing object can be lighted.

A panel which may be lighted and which may display messages or change color is thereby disclosed.

These and other objects and advantages of the invention will become better understood hereinafter from a consideration of the specification with reference to the accompanying drawings forming part thereof, and in which like numerals correspond to parts throughout the several views of the invention.

### DRAWINGS

### DESCRIPTION OF DRAWINGS

For a further understanding of the nature and objects of the present invention, reference should be made to the following detailed description taken in conjunction with the accompanying drawings in which like parts are given like reference numerals and wherein:

FIG. 1 shows an exploded plan view of a typical three layer lay-up using a two part mold utilizing the non-absorbent core using a knitted plastic material such as green house shade cloth as taught in this specification.

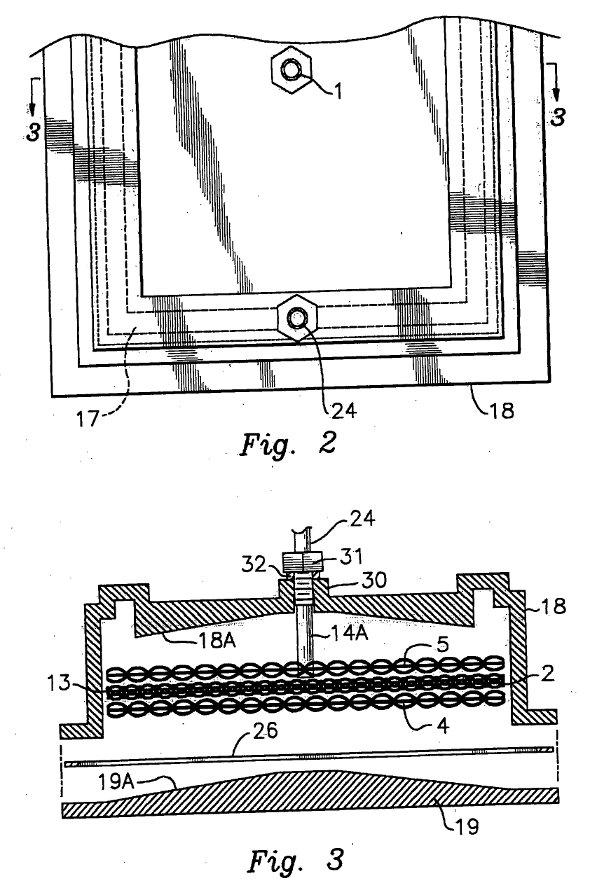

FIG. 2 is a top view of a section of the embodiment shown in FIG. 1.

FIG. 3 is a cross sectional view of the embodiment shown in FIG. 2 through the 3-3 axis of FIG. 2.

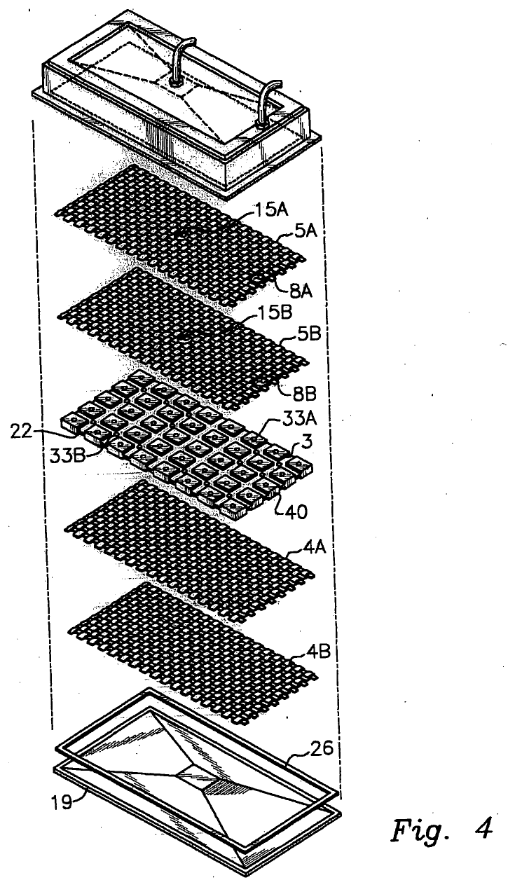

FIG. 4 shows an alternate embodiment exploded view using sheet goods such as plywood, or foam as the non-absorbent core.

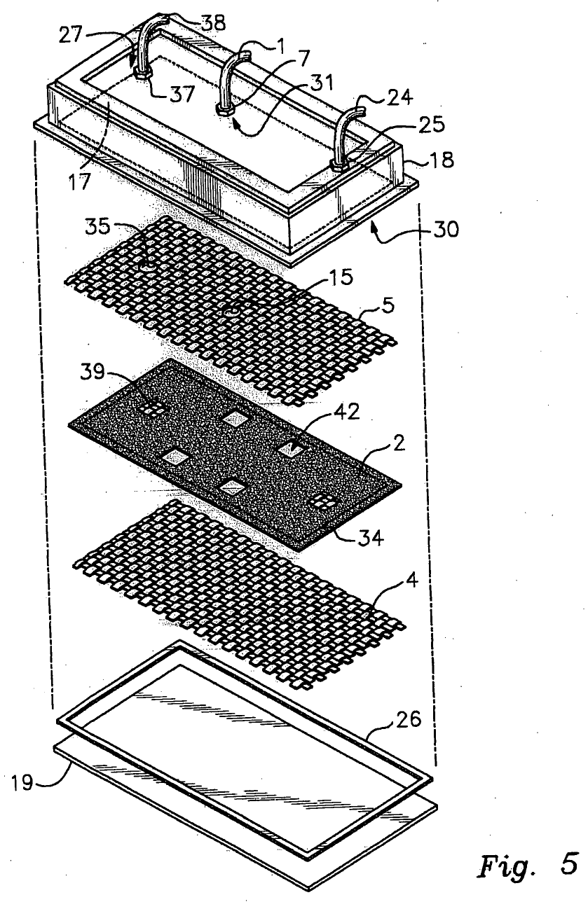

FIG. 5 shows an alternate embodiment exploded view using sheet goods such as plywood, or foam as the non-absorbent core wherein the core defines cut outs which may be filled with absorbent material and showing multiple input lines.

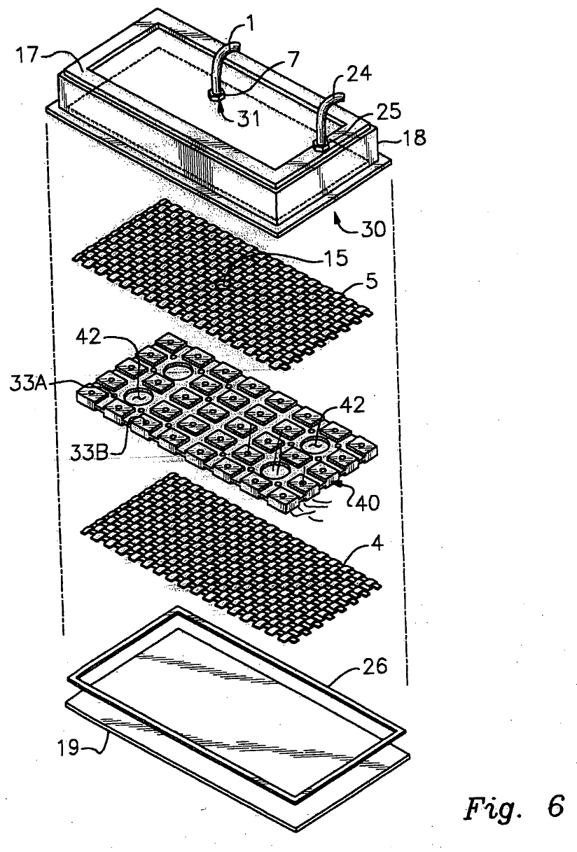

FIG. 6 shows an alternate embodiment exploded view using sheet goods such as plywood, or foam as the non-absorbent core wherein the core defines cut outs which may be filled with absorbent material.

FIG. 7 shows an alternate embodiment exploded view using both woven and sheet goods such as plywood, or foam as the non-absorbent core with multiple absorbent reinforcing layers.

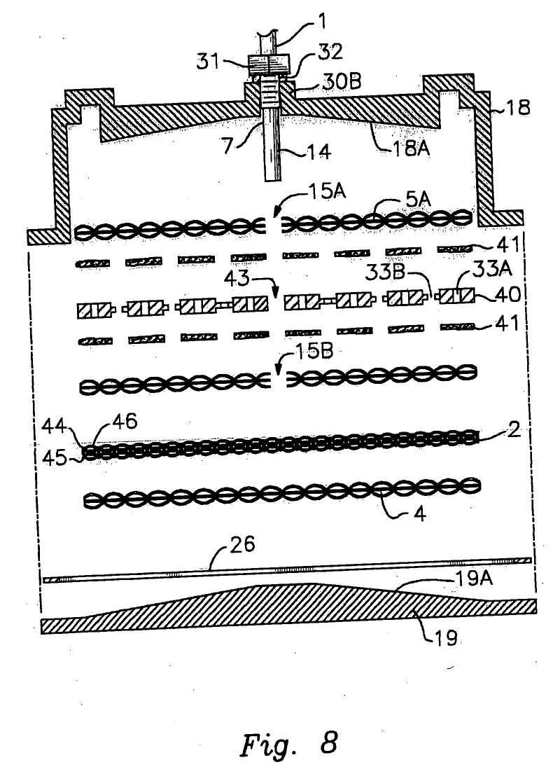

FIG. 8 shows an alternate cross sectional embodiment exploded view using sheet goods such as plywood, or foam as the non-absorbent core wherein the core is joined to the absorbing layers using layers of bonding material.

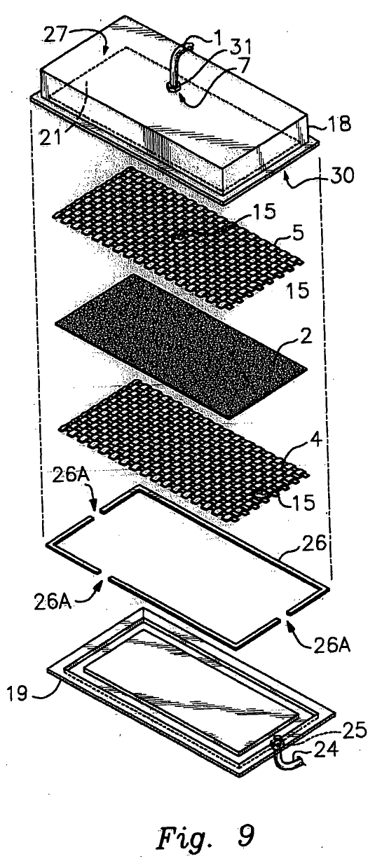

FIG. 9 shows an alternate embodiment exploded view using a bottom resin drain.

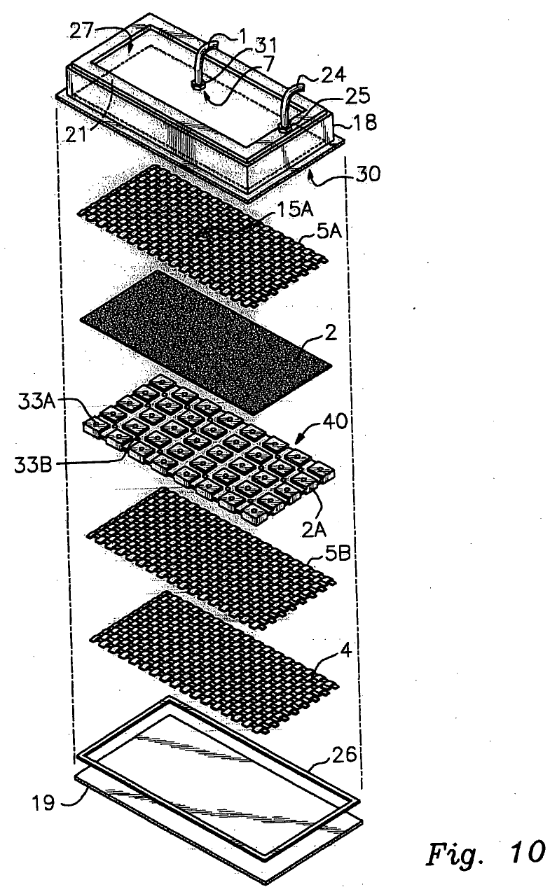

FIG. 10 shows an alternate embodiment exploded view using woven and sheet goods such as plywood, or foam as a common non-absorbent core.

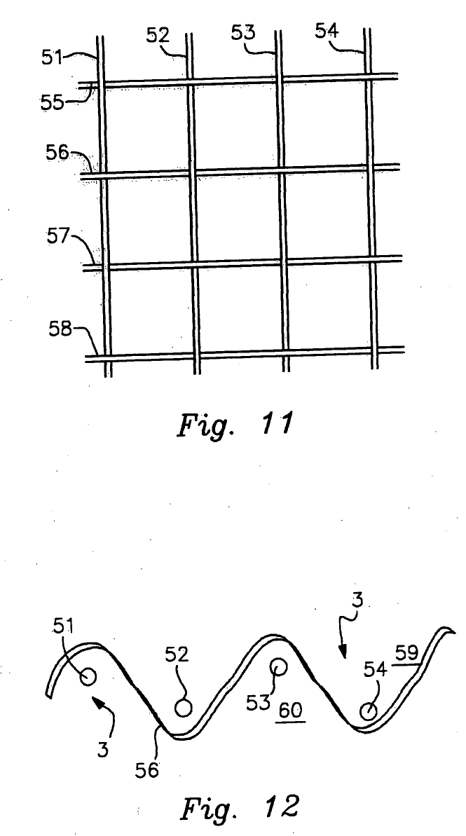

FIG. 11 shows a top view of a non-absorbent weave of the type which might be used to practice the invention.

FIG. 12 shows a cross sectional view of the weave shown in FIG. 11.

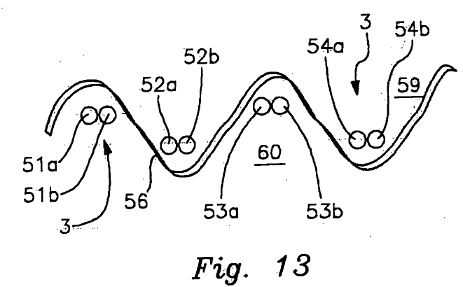

FIG. 13 shows an alternative thread design to that shown in FIG. 12.

FIG. 14 shows a cross section of an alternate thread design and absorbing layer.

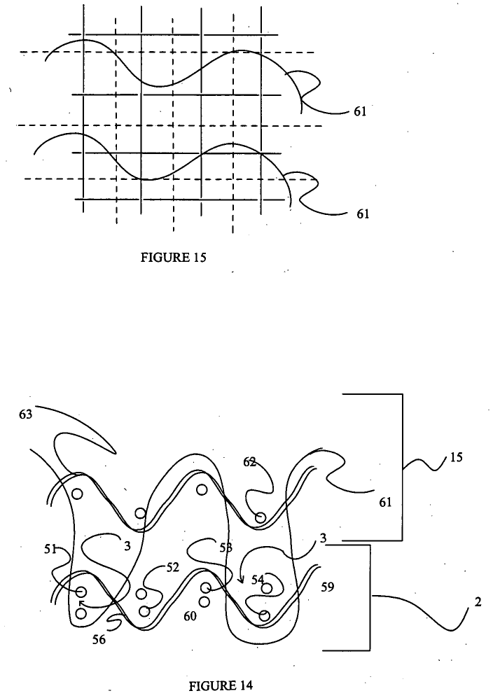

FIG. 15 shows a top view of the weave shown in FIG. 14.

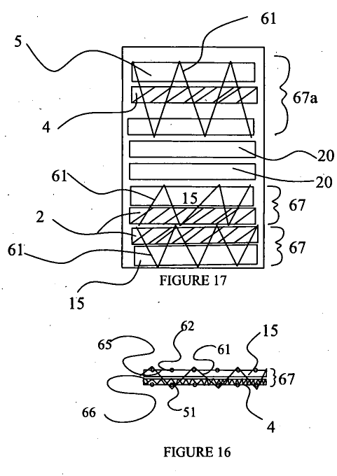

FIG. 16 shows a cross section of layers tied by threading.

FIG. 17 shows a lay up with a section of top and bottom absorbing layers tied by threading.

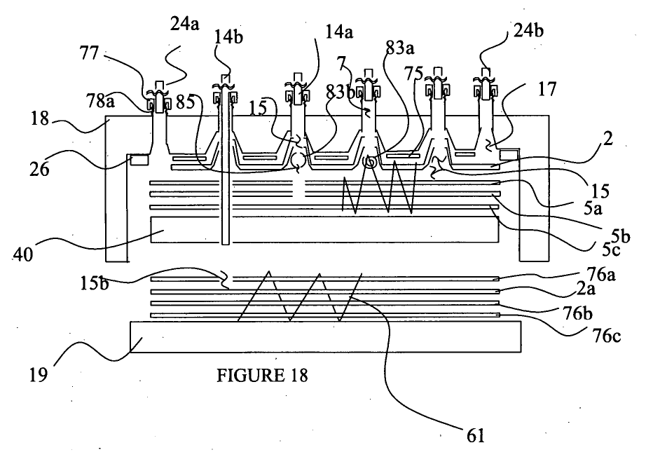

FIG. 18 shows a mold being used for distribution of resin using the methods described herein.

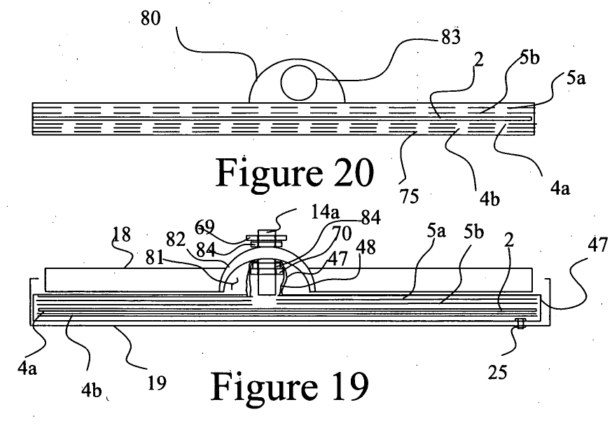

FIG. 19 shows an alternate embodiment where a vacuum bag is substituted for the mold seal.

FIG. 20 shows a product produced using the mold and lay up shown in FIG. 19.

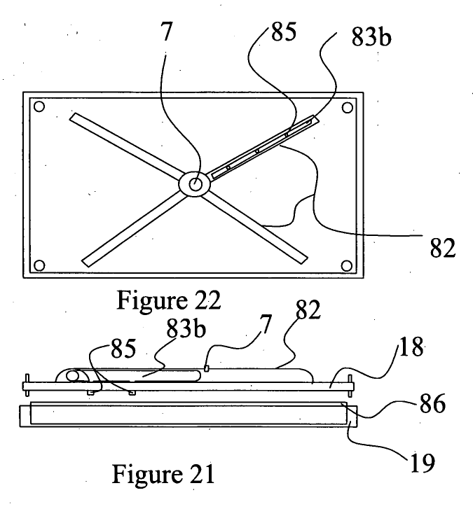

FIG. 21 shows a side view of a mold used in conjunction with the model taught in FIG. 20.

FIG. 22 shows a top view of a mold used in conjunction with the model taught in FIG. 20.

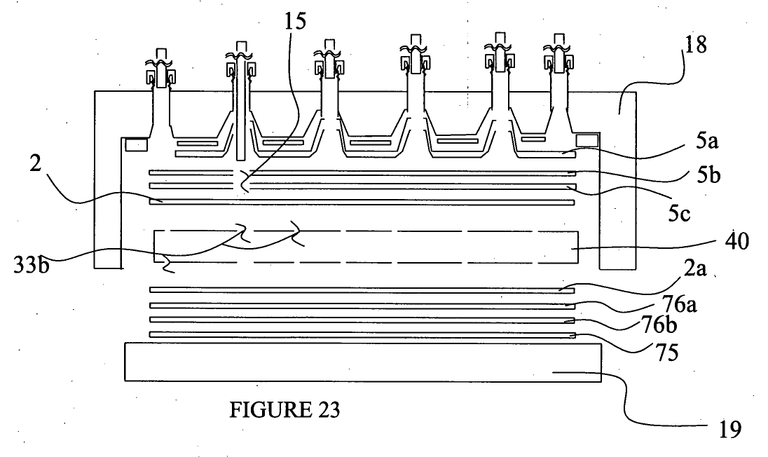

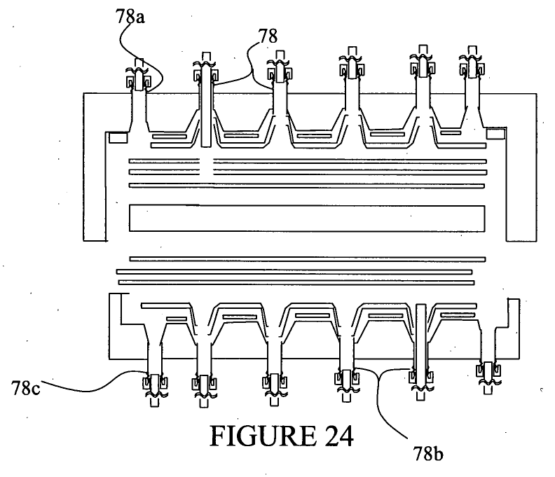

FIG. 23 shows an alternate embodiment of the mold and lay up taught in FIG. 19.

FIG. 24 shows a second alternate embodiment of the mold and lay up taught in FIG. 19.

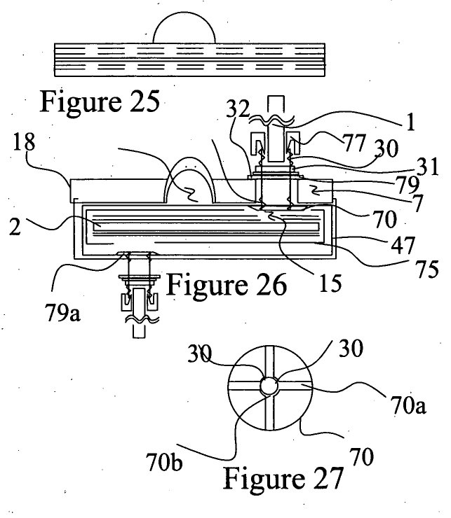

FIG. 25 shows a modification of the product taught in FIG. 20.

FIG. 26 shows the alternate mold and lay up to make the product taught in FIG. 25.

FIG. 27 shows a bottom view of the bottom bolt from FIG. 26.

FIG. 28 shows a lay up using a vacuum bag with fiber optics.

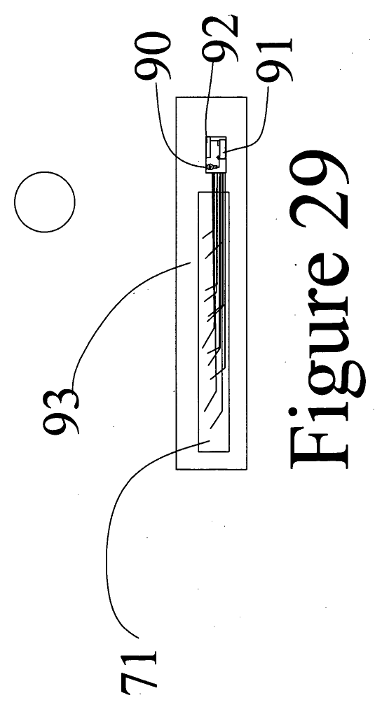

FIG. 29 shows a finished panel.

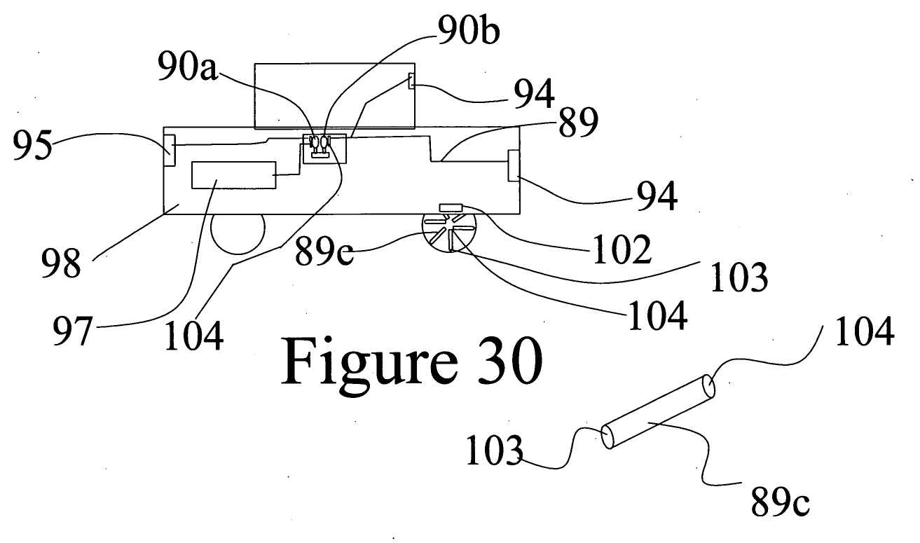

FIG. 30 shows how panels may be lit be an exterior source.

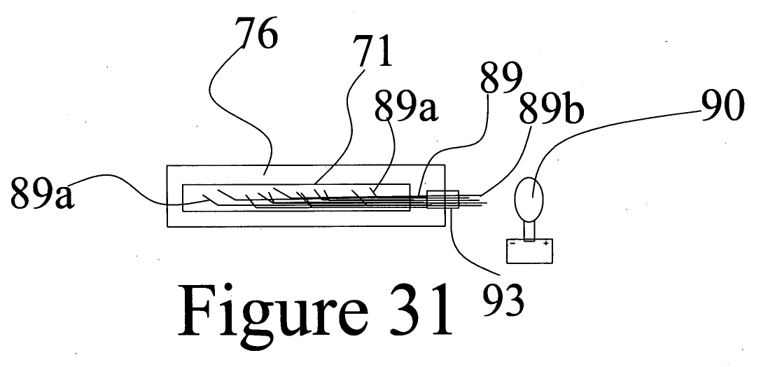

FIG. 31 shows an alternate finished panel.

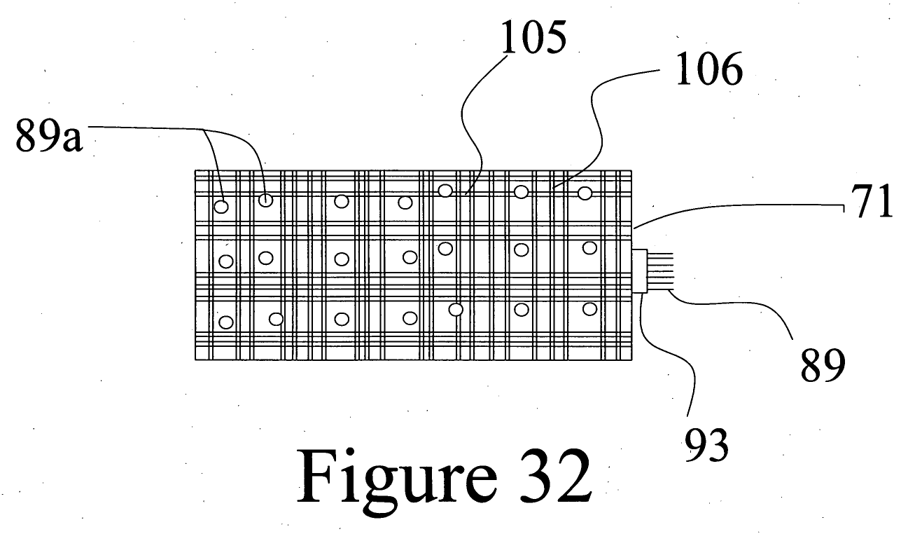

FIG. 32 shows a top view of a finished panel.

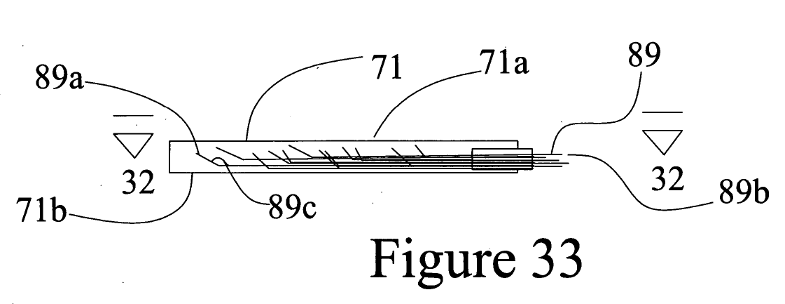

FIG. 33 shows a side view of the finished panel through the 33-33 axis of FIG. 32.

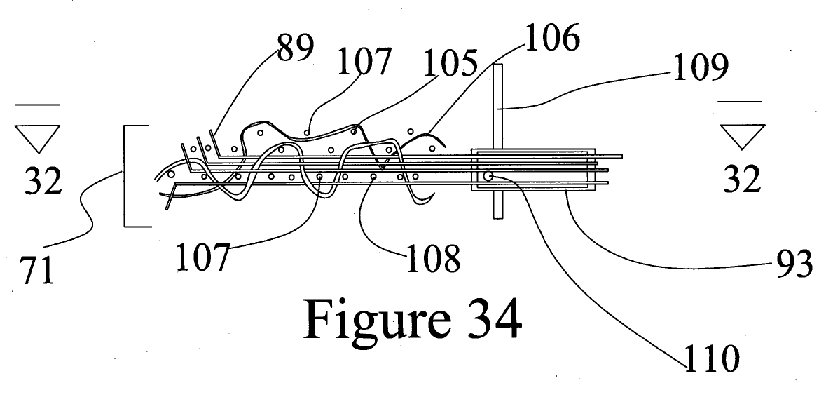

FIG. 34 shows a side view of the fiber optics within layer 71.

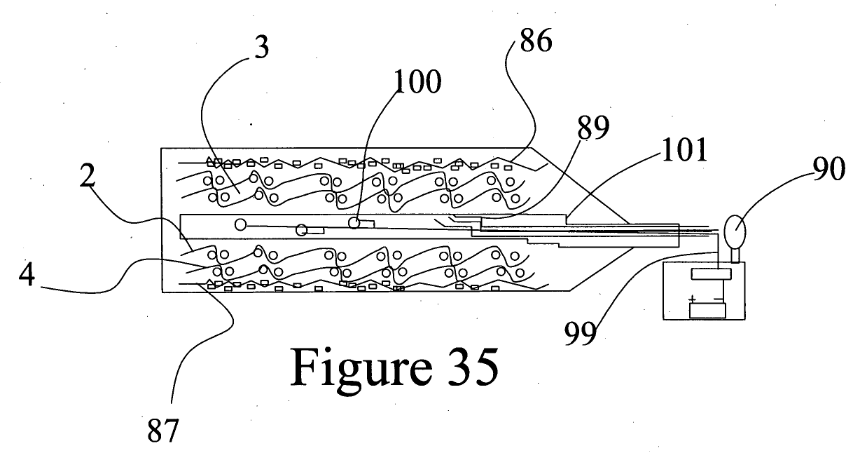

FIG. 35 shows an alternate lay up for protecting fiber optics.

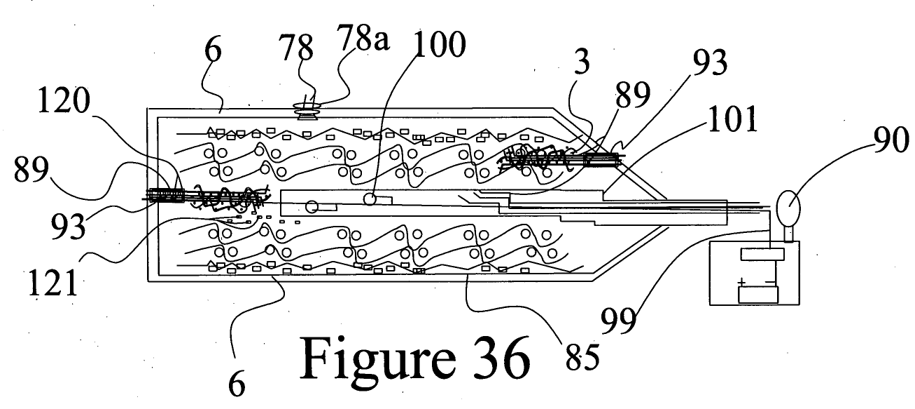

FIG. 36 shows how multiple lit layers can be used in a panel lay up.

### DETAILED DESCRIPTION OF THE PREFERRED EMBODIMENT

Referring to FIG. 1, the invention comprises a mold 6 having a mold top 18, a mold bottom 19 and a seal 26. Since this particular invention allows for both pressure resin impregnation and vacuum resin impregnation, the seal 26 may not be absolutely necessary in all embodiments. However, in most cases, even using pressure, a partial seal, such as is shown in FIG. 9 would be necessary to control the resin and prevent waste of resin.

In order to let air escape in a pressure resin induction system where the mold is air tight or in order to draw a vacuum in a vacuum induced resin impregnation system, a resin output tube 24 is provided which fits into the interior of the mold through a output opening 25 which may use an identical sealing mechanism having raised hollow bolts 30, fixed nuts 31, and washers 32.

In order to have the vacuum spread evenly throughout the interior of the mold a vacuum perimeter 17 is provided along the perimeter of the mold top 18 so that the vacuum draws evenly throughout the entire mold.

In FIG. 1, this non-absorbent passage 8 appears to be directly below the top opening and resin output tube 24, although this is not necessary.

The lay up 36 comprises a top layer of resin-absorbent material 5 which is typically referred to as reinforcing material. This top layer of resin-absorbent material 5 may also be described as a fiber reinforcement layer 5. The resin typically saturates and bonds the material which either absorbs or expands or dissolves partially in the presence of resin. The resin-absorbent material 5 defines a non-absorbent passage 15. The non-absorbent passage 15 is preferably below the top opening 7 so that the resin is introduced through the input tube 1 it immediately may pass through the passage 15. Below the top layer of absorbent material 5 is at least one substantially non-absorbent layer 2. At least a portion of the non-absorbent layer communicates with the non-absorbent passage 15. The non-absorbent layer 2 comprises a non-absorbing means for allowing the passage of resin throughout the non-absorbing layer 2 without substantial degradation of the non-absorbent layer 2 when in contact with resin and without substantial swelling. These properties of the non-absorbent layer 2 allow substantially unimpaired flow of the resin through channels 3 (which can be seen in FIG. 3) throughout the non-absorbing layer 2. It is, therefore, one purpose of the non-absorbent passage 15 to allow the resin to enter the channels 3 or the non-absorbent layer 2 without having first absorbed or carried a substantial amount of dissolved material from the resin-absorbent material 5. The combination of the channels 3 of the non-absorbing layer 2 and the non-absorbent passage 15 allow the unimpaired flow of resin. The flow is not so impaired as to improperly fill the lay up with resin and where the resin is absorbed in a quick enough rate so that the channels 3 are not sealed prior to distribution of resin throughout the layout 36.

As shown in FIG. 1 a bottom layer of resin-absorbent material 4 may be present. In this way, the non-absorbent layer 2 may be sandwiched between two absorbent layers. One of the purposes of accomplishing this is to produce a fully impregnated product without having to dispose of a resin distribution means. The resin distribution means in this case is the non-absorbent layer 2 and the non-absorbent passage 15 which allows for the passage of resin through the top resin absorbent layer 5 to the non-absorbent layer 2.

FIG. 3 is a cross section of the mold shown in FIG. 1. In the cross section shown in FIG. 3, the channels 3 can be seen to be comprised of holes defined by a weave of non-absorbent strands. The construction of weaves is well-known, but for the benefit of being substantially over descriptive FIG. 8 shows the numbered parts of a weave which include a cross-running strand 44, bottom cross running strand 45 and a middle strand 46 which would run in the opposite direction to the strand 44 and 45, although the exact weave could vary as long as it defines channels 3 through which the resin could flow. This is described more below in the discussion of FIGS. 11-13.

Also shown in FIG. 3 is the interior 18a of the top mold and the interior of the mold bottom 19a which serves to provide a shape to the lay up. It is therefore another improvement of the invention to provide a non-absorbent mesh for the distribution of resin throughout a lay up with a distribution means, the flexible layer of non-absorbing material 2, which can assume the shape of the interior surfaces 18a and 19a of a mold 6.

The non-absorbent layer 2 may comprise of which may either adapt in shape to the interior of the mold when flexible materials are used. Some examples of non-absorbent layer materials include plastics, glass, wood, foam, woven or knitted filaments or monofilament, green house shading, beads, a weave of non-absorbent material having a series of channels such as knitted polyethylene, wood defining grooves or channels in holes in order to allow the resin to move throughout the mold, metal, ceramics and the like. Typically, it is important that the channels be at least 1/16 of an inch in order to allow adequate resin flow although depending on the viscosity of the resin and the amount of pressure put on the mold, the size of the channels may be varied. Typical examples of absorbing materials for the bottom layer of absorbing material 4 and the top layers of absorbing material which are also known in the art as reinforcing layers, include carbon fiber, cloth and fiberglass which is also known as chop strand mat, veil mat, sterling paper, continuous strand mat, KEVLAR, and SPECTRA. These are generally known in the art.

Channels 3 defined by the weaves in the embodiment shown in FIG. 1 are typically greater than 0.0075 inches and are typically less than 0.6 inches. The non-absorbent passage 15 is typically at least 25% of the diameter of the input opening 7 in order to prevent excessive introduction of dissolved material from the top layer 5 of absorbing material. This non-absorbent passage is usually between 1/16 of an inch and 3 inches in diameter although it may be larger. In addition, the non-absorbent passage 15 should be an opening although in other embodiments it may contain a non-absorbing material such as the material from the group described above when referring to the non-absorbent layer 2 as long as-the passage of resin is not restricted thereby.

Typically, the non-absorbent passage has a depth of no more than 3 inches but is at least 1/64 of an inch.

In order to further prevent the restriction of resin, a resin out non-absorbent passage 8 may be defined between the non-absorbent layer 2 and the vacuum perimeter 7 in the absorbent mat 5.

In FIG. 1, this outlet non-absorbent passage 8 appears to be directly below the resin output tube 24, although this is not necessary.

FIG. 3 shows a resin out tube 14a which may go from the non-absorbent layer 2 to tube 24.

Tube 14a may go to any point in the vacuum perimeter 17.

As can be seen by reference to FIG. 4, there may be more than one layer of reinforcing material which is typically referred to herein as resin absorbing material. There may be a first top layer of absorbing material 5a and a second top layer of absorbing material 5b. As can be seen by reference to FIG. 4, each of the top absorbing layers, 5a and 5b would define top non-absorbent passages 15a and bottom non-absorbent passage 15b. In FIG. 4, grooves 3 are defined in a solid block of-material. Holes 33 go through the center of the solid block of material in order to allow resin to pass.

Holes 33a are located outside of the grooves and holes 33b are within the grooves 3. Both the holes 33a and 33b and the grooves 3 comprise the channels referred to generally as 3 in this embodiment. The embodiment shown in FIG. 4 also shows the presence of first bottom absorbing layer 4a and a second bottom absorbing layer 4b. It is obvious to one skilled in the art, that the number of layers may vary as long as all of the top layers 5a and 5b define non-absorbent passages 15a and 15b so that the resin may pass from the input opening 7 through to the non-absorbent layer 2.

FIG. 5 shows another embodiment. Two improvements are shown in the embodiment shown in FIG. 5. One improvement is the presence of a second input tube 38 passing through a second opening 37 which is sealed with the same mechanism present for tubes 1 and 24. In larger molds it may be necessary to have multiple input openings and indeed may even be necessary to have multiple outlet openings 25 where vacuum assisted process is being used.

Again, it is necessary that a non-absorbent passage 35 be provided for the passage of resin from tube 38 into the non-absorbent layer 2.

Also shown in FIG. 5 are certain modifications to the non-absorbent layer 2 which are possible. At least one strand of absorbent material 34 may run through the non-absorbing matrix of the non-absorbing layer 2. The purpose of this strand 34 would be to reinforce the contact between the non-absorbent layer 2 and the fiberglass absorbent material 4 and 5. In this way, it may serve in order to reinforce the perimeter 21 of the non-absorbent layer 2 and in fact, the entire perimeter of the non-absorbent layer 2 may comprise absorbent material woven into the non-absorbent layer 2 in order to reinforce this contact. Another method of practicing this technique is to have cut outs 42 in the non-absorbent layer 2 which would allow the top absorbent material 5 to actually contact the bottom absorbent material 4. Likewise, the cut outs 42, which may extend all the way to the perimeter of the non-absorbent layer 2, may be filled with resin-absorbent patches 39 as shown in FIG. 5. Patches 39, may be necessary where a thicker non-absorbent layer 2 is used or where non-absorbent layers 2 are built out of wood or other materials. FIG. 6 shows the presence of cut outs 42 in a wooden non-absorbent layer 2. It is obvious that the perimeter 21 of the non-absorbent layer 2 may be smaller than the perimeter of the absorbent layers 4 and 5 so that the sandwiching affect is accomplished without the use of absorbent strands 34 or cut outs 42. The cut outs 42 or absorbing strands 34 might still be necessary in order to secure the top absorbent material 5 to the bottom absorbent material 4 at the center of the non-absorbent layer 2.

FIG. 8 shows the existence of a tube from the input tube to the non-absorbent layer as is described in FIG. 3. FIG. 8 is a cross section of the mold shown in FIG. 7. This shows how in thicker molds, multiple non-absorbent layers 2 and 2a may be present as well as at least one middle absorbing mat 20.

FIG. 8 shows an opening tube 14. Tube 14 would carry the resin through the top absorbing material 5 to the non-absorbing layer 2. The tube 14 may become a part of the lay up when resin is introduced or could be made of a material to which resin would not bond so that it could be removed from the lay up after the resin was introduced.

FIG. 9 shows how the resin output tube 24 (for drawing a vacuum to draw resin into the mold) and vacuum perimeter 17 may be located on the mold bottom 19 as opposed to the mold top 18. It would be obvious that the placement along the middle of the mold or any of the inlet or outlet tubes is taught by the disclosure set out herein.

The process may be described according to the following description:

A method of flowing resin from an inlet opening into a fiberglass lay up comprising at least one non absorbent mesh core defining a plurality channels formed by the mesh weave for the passage of resin located below at least one top layer of fiber reinforcement layer, said top layer defining an opening substantially below the inlet opening through the at least one top layer to the non-absorbing layer comprising the steps of:
A) Flowing said resin through the opening defined by the fiber reinforcement top layer, said hole having a diameter and length sufficient to prevent excessive restriction of the flow of the resin from the inlet opening through a path defined by said opening to said non-absorbent layer,
(B) Flowing said resin along the channels defined by the non-absorbent layer through and along said non-absorbent layer, and
(C) Flowing said liquid resin from said non absorbent layer channels into the fiber reinforcement layer.

The process further comprising a bottom fiber reinforcement layer below the non-absorbent layer and comprising the additional step of:
(D) Flowing liquid resin from said non absorbent layer channels into the bottom fiber reinforcement layer.

The process flowing may include the step of drawing a vacuum on the non-absorbent layer to draw resin into the non-absorbent layer.

The process of flowing may comprise the step of introducing the resin under pressure into the inlet opening.

Another approach to understanding the invention is to describe the preparation of the lay up.

(1) First, a suitable mold is prepared, having a top and a bottom and the top of the mold is removed.

(2) At least one layer of fiberglass matting is laid into the mold.

(3) At least one layer of non-absorbing mesh material defining multiple channels through which the resin can pass through to both the bottom layer and a top layer to be added is placed above the bottom layer of fiberglass matting.

(4) Then a top mat is placed over the non-absorbing layer, to expedite this, the layers may be sewn together.

(5) A hole is cut through the player to allow resin to pass. The hole may be either in the top layer of matting or the bottom layer of matting and would run to the middle non-absorbing layer defining multiple channels. The hole (or multiple holes under multiple resin inlets) would have to be of sufficient size to allow the resin to fill the entire mold given the pressure.

(6) Another step in the process using the lay up would comprise flowing resin through the hole into the non-absorbing layer.

One limitations in connection with the preferred embodiment would be to have a core comprised of a weave of non-absorbing material defining a plurality of channels.

This step might further be described as flowing resin through an opening provided in the mold into a non-absorbing passage in either the top or bottom absorbing layer into the non-absorbing layer.

The step of flowing the resin may also include the step of drawing the resin into the mold by placing a vacuum within the mold or flowing the resin into the mold by applying pressure to the resin prior to its entry into the mold. An additional step of compressing the two halves of the mold together could also be added.

Flowing of the resin into the mold through the non-absorbing passage could be further defined as comprising a step of flowing the resin through an inlet substantially over the non-absorbent passage through the passage into the non-absorbing layer.

An additional step which could be added would be-the step of curing the lay up while it was still under a vacuum.

Alternatively, a final step could be removing the vacuum and allowing the resin to cure.

Another step could be added which would be to add a layer of bonding material to at least one side of the non-absorbing layer to allow it to better bond to the top or bottom mat.

Yet another modification to the step of providing a hole would be the step of driving an internal resin tube from the opening in the mold through which resin enters through at least one of the absorbing mats into the non-absorbing layer.

Yet another step could be removing the internal resin tube prior to the resin curing which could be followed by the step of filling the opening left by removing the internal resin tube with resin as a mixture of resin and reinforcing matting.

The fiberglass mat (may be a three ounce mat).

The non-absorbing (material may be woven PET recyclable plastic).

The opening is of at least ⅛ inch in diameter or ⅛ the size of the fiberglass inlet providing resin to the matrix defined herein.

The size of the passages 15 is governed by the number of input openings 7 and corresponding channels 15 and the internal volume of the mold to be infused with resin.

The mold 6 itself typically has two parts, a top 18, a bottom 19 wherein the top 18 has an internal surface 18a shaped to correspond to the shape of the top of the desired end product, and wherein the bottom has a bottom surface 19a shaped to correspond to the shape of the desired end product. The internal surfaces of the mold 18a and 19a ultimately contact the absorbing layers 5 and 4 in the preferred embodiment, at least when these layers are expanded through the absorption of fiberglass resin.

The non-absorbent layer may consist of a weave of a non-absorbing material 2. Alternative embodiments as shown in FIG. 1 may use a solid core 40 as shown in FIG. 4 to accomplish different purposes. It may consist of more than one layer as shown in FIG. 10 where one layer may be woven 2 and another solid 20. The solid core 40 layers are typically a solid product with cut grooves as shown in FIG. 4. Holes 33 are also present to allow resin to pass to bottom layers 4.

The perforated solid core 40 may be made of flexible material can adapt to the shape of the mold interior.

Where a thicker mold is desired, such as is shown in FIG. 7, there may be a lay-up comprising a first top layer 5a comprising a non-absorbent passage 15a, then a first core 40 shown here as a solid core which defines a core passage 43, then a middle absorbing matt 20 defining a bottom non-absorbent passage 15b continuous with the core passage 43 and the non-absorbent passage 15a followed by a second non absorbing layer 2 shown here as a weave which also functions as a resin carrying core followed by one or more bottom layers 4 of absorbing material. While two different types of cores are shown in FIG. 7, the cores may both be woven or both solid cores to accomplish different purposes. This pattern may be repeated as many times as necessary in order to have a completed mold with two or more cores communicating by way of one or more non-absorbing passages 15. Similarly, one or more of several flow cores in such a series of layers may communicate with a separate inlet channel 35 as shown in FIG. 5. In this way bottom cores may be fed resin directly, as by running tubes 14 through the intermediary layers (and cores) as shown by FIG. 8, so the resin may pass core 40 and go directly into non-resin absorbing woven layer 2.

The lay up 36 is seen to be comprised of the top layer (comprised of one or more plies) 5, bottom layer 4 (comprised of one or more plies) and non-absorbing core layer 2 (comprised of one or more cores) and that this arrangement may be, repeated as necessary.

This lay-up 36 is placed in the mold bottom 19. The mold top mold 18 is placed on top of the lay-up 36. Where a vacuum is used, the mold top 18 and bottom 19 are sealed around the perimeter with a vacuum seal 26 which may be a gasket or a bag. This arrangement seals the two halves of the mold 18 and 19 together creating a partially sealed chamber between the two mold halves receiving resin through the input opening 7. A polypropylene fitting comprising a bolt 30 for receiving a hollow fixed nut 31 and a washer 32 serves to seal the inlet tube 1 within the input opening 7. This arrangement may be varied in many ways as long as the passage of resin is allowed by the arrangement. The passage 15 must be located approximately below the input opening 7. For this reason, in many cases, the passage 15 may be cut after the mold top 18 is put in place through the input opening 7. Preferably, the lay-up will be laid precisely enough so that the opening 7 may be cut in advance.

In the preferred embodiment, the bolt 30 may be defined by the mold top 18 for receiving the tube 1. A vacuum opening 25 is placed in the mold top 18 as shown in FIG. 1 or the mold bottom as shown in FIG. 9 which receives a resin output tube 24 through which the vacuum is applied to the inside of the mold. A vacuum perimeter 17, which is essentially a groove around the internal surface of the mold, connects the approximate perimeter of the mold to the vacuum opening 25 to help distribute the vacuum applied to the mold. Where a pressure induced system is used, the seal 25 may define perforations 26a to allow resin out in various locations.

Where a vacuum is desired, a vacuum is pulled on the two molds via the resin output tube 24. The seal 26 is usually flexible so that the vacuum compresses the two halves of the mold together against the lay-up 36. Mechanisms may be provided to minimize or maximize movement of molds together to allow for a better seal and to have the two inner faces 18a and 19a press more closely to the lay up. Examples are where the seal 26 is large enough to allow the molds to compress together or where the mold itself can flex to have the faces 18a and 19a move inward under the vacuums.

While under vacuum, fluid resin is allowed to enter the lay-up 36 by way of the resin inlet tube 1 emptying into the input opening 7 defined by the inside of tube 14 as shown in FIG. 8. The resin enters the non-absorbing layer 2 or 40 primarily through the passage 15 and continuously flows through the non-absorbing layer 2 outwardly to the lay-up non-absorbing layer perimeter 21. As the resin flows outward to the perimeter the resin also flows upward and saturates the upper plies 5 and flows downward saturating the lower plies 4 until the lay-up 36 is saturated.

The resin may be allowed to cure while still under vacuum. The vacuum is then turned off and the-two molds pulled apart and the lay-up, no saturated with resin and hardened is removed from the mold.

Several variations of this process are possible.

The mold may be replaced with a silicone bag or a silicone bag 47 may be used to seal the vacuum around the mold as shown in FIG. 19. Looking at FIG. 3, this may be also envisioned by having the mold top 18 be of a flexible sheet of silicone sealed on the perimeter and the bottom by seal 26 which would also be a silicone sheet. Since the silicone bag flexes, as it is placed over the mold bottom 19, it assumes the shape of the internal surface of the mold bottom 19a.

The mold may be replaced with a vacuum film which is identical structurally to the silicone bag 47. The vacuum perimeter 17 may be maintained by placing a coiled spring or piece of rope around the perimeter of the bag. In this case it maybe desirable to use a peel ply layer 48 between the vacuum film and the flow core lay-up to allow the vacuum to be evenly drawn as shown in FIG. 19. It is not necessary but may produce a more uniform finish on the inside of the part.

As shown in FIG. 8, a layer of bonding material 41 may be placed on the top and bottom of the core 40 to enhance bonding between the non-absorbing layer and the absorbing layer. Here the bonding material 41 is shown to be broken to keep open the holes 33B in the channels 3 between the raised squares 22 of the core 40.

As can be seen by one skilled in the art, the absorbing layers 4 and 5, also known as reinforcing layers may be fiberglass mat, carbon fiber, cloth or other materials capable of absorbing resin without departing from the process taught herein. Some examples are chopped strand matt (typically ½ to six ounce), veil matt, sterling paper, continuous strand matt, fiberglass, carbon fiber, KEVLAR, SPECTRA and PET.

The non-absorbent layer may be replaced with any woven material which is not fiberglass absorbing, or which absorbs fiberglass at a sufficiently slow rate so as not to cause undue expansion so as to seal the channels 3 defined by the non-absorbing means 2 or 40. (Such as woven or knitted greenhouse shading—10%-95% or many other known matts or monofilament which do not absorb resin). Some examples of solid cores 40 are wood; foam, metal, ceramics, and plastic (having grooves or channels and holes). The plastic, foam or ceramic or wood defines grooves which supply fiberglass resin throughout the matrix.

In one embodiment, the non-absorbing layer 2 would further comprise at least one absorbing strand 34 of fiberglass absorbing material woven through the otherwise non-absorbing weave or layer 2 as shown in FIG. 5. This, would allow for better bonding between the layers. This limited application of absorbing strands 34 would have to be sufficiently disbursed so that expansion of the absorbing material would not hinder the flow of the resin through the non-absorbing layer 2. Additionally, to enhance bonding, the non-absorbing layer could be provided with a weave of absorbing material 34 around at least a portion of the perimeter 21 (shown in FIG. 1) of the non-absorbing interior.

Patches 39 of absorbing material could be placed at strategic locations within the perimeter of the non-absorbing layer 2 as shown in FIG. 5. This, similarly, would enhance bonding between the three or more layers of the lay up (2,5 and 4). The key would be to have sufficient separation between the patches 39 so that the resin flow through layer 2 would not be disrupted to a degree that would leave the mold inadequately filled with resin.

Where wood or other less permeable layers are used, the lay up might include a layer of bonding material 41 between the non-absorbing layer 2 and the fiberglass absorbing layers 5 and 4. This bonding material would allow for the fiberglass resin to bond to the wood or other core material.

In another embodiment, as shown in FIG. 5, the at least one non-absorbing layer would further comprise a series of openings 42 of sufficient size to allow the top mat 5 and bottom mat 4 to substantially meet or otherwise provide a reduced distance between the top and bottom mat.

In this embodiment, the size of these holes would typically be at least ⅛ inch in diameter although the shape of the openings may be square, round, etc.

There are several improvements present when utilizing this invention.

First, since the non-absorbing layer is embedded within the matrix, it does not need to be otherwise disposed of.

The non-absorbing layer may have absorbing patches located throughout its surface in order to bind with the fiberglass on either side. Similarly, if wood is used with the non-absorbing layer of the matrix, it may be at least partially coated with a bonding material to allow it to better bond with the fiberglass.

Similarly, the non-absorbing layer may define holes in it sufficient to allow the top mat to better join the bottom mat.

In the preferred embodiment this is not necessary since the monofilament non-absorbing layer 2 is thin enough so that there is an adequate penetration of resin from the top layer to the bottom layer to give strength to the unit. For some uses, for the sake of safety, it might be desirable to define holes 42 or fiberglass patches 39 as discussed above throughout the non-absorbing member for the purposes of enhancing the bond between the top fiberglass layer and the bottom fiberglass layer as defined in more detail herein. These patches 39 may also be described as having interspersed absorbing and non-absorbing portions of the substantially non-absorbing layer using the definitions of function and structure discussed above.

Examples of weaves for layers 2, which are known in the art of weaving, include linen weaves, twill weaves, weft fabric, warp fabric, rib fabric, interlocking weaves, tucked weaves, and the like. All these weaves would work to some extent since it is a common features of most, if not all, weaves, that spaces, shown as channels 3 in FIG. 3, are generated as a by-product of weaving threads.

FIG. 11 shows a view of a swath of linen weave involving vertical threads 51 through 54 and horizontal threads 55-58. As shown in FIG. 12, a cross section shows that channels 3 are formed in the above areas 59 and below areas 60 from the intersection of the vertical thread 56 and horizontal threads 51-54. Channels 3 include these large areas as well as possible smaller size areas formed in the spaces that may exist between the horizontal and vertical threads.

FIG. 13 shows an example of another type of weave, here a twill weave. This twill weave has two vertical threads, broken into 51a and 51b through 54a and 54b. Additional space in the channels 3 may be defined by having these additional threads. This example can, of course, be applied to other types of weaves which would provide more or less channel space. The thickness of the weave and size of the channel 3 are increased in FIG. 13 by increasing the number of threads in a layer. Similarly, the thickness of the weave may be varied by increasing the size of the threads or by increasing the number of layers of weave.

The use of weaves provides for greater flexibility of the non-absorbing layer 2. In addition, the non-absorbing layer may be much thinner than the non-absorbing layers which are created with solid non-absorbing strata such as cores shown in some prior art.

Another embodiment of the invention would also incorporate an internal resin tube 14a shown in FIG. 3, 14 and in FIG. 8 leading from the resin inlet through opening 7 within the tube 14 and fixed nut 31 through the passage 15 to the non-absorbing layer 2. This would be particularly useful where thick lay ups have multiple top layers 5 and multiple non-absorbing layers 2 or cores 40 so that the resin must travel a substantial distance within the mold 6. This internal resin tube might ultimately become a part of the mold and hence may have the same qualities as the core non-absorbing layer as described above or may have walls made of resin absorbing material.

In some large-scale productions, it might be desirable to have this internal resin tube 14 have a tip which is sharpened so that it could cut the hole through to the non-absorbing layers 5. Similarly, the non-absorbing layer 2 could have at least one portion of it be fragile so that the fiberglass cut by the tube, could be pushed into the fragile non-absorbing portion.

It can be seen by reference to FIG. 8 that the two filaments may be a top cross running strand 44 and a bottom cross running strand 45 and a middle strand 46 which top and bottom cross running strands 44 and 45 run perpendicular to the middle strand 46 so that a space is formed between the top strand, the bottom strand and middle strand. These spaces between strands 44, 45 and 46 are the channels 3 through which the resin may flow throughout the non-absorbing layer to the entire lay-up.

The number of layers of fiberglass absorbing and non-absorbing weave or core materials may be varied as long as a sufficient amount of resin can get to each layer. Likewise, multiple layers of weave may be separated by multiple layers of non-absorbing channel providing means in the form of non-absorbing layers 2 or cores 40.

Likewise, there is no restriction on either the number of resin openings entering the mold nor the number of vacuum openings into the mold nor the number of openings for resin under pressure to leave the mold. All of these minor modifications would be made consistent with the size of the mold and the materials to be used, as well as temperature and viscosity of resin.

FIG. 4 shows the solid core 40 is slotted in both directions to allow the resin to flow the length and width of the core 40 holes 33b are-drilled through the slots to allow the resin to go to the bottom side of the sheet to saturate the lower plies. The individual blocks of core material may be in matrix with a flexible scrim material as shown in FIG. 7 as layer 2. These solid cores and absorbing layers may be joined with staples or with threads as described with weaves in the following discussion.

The embodiment of the invention shown in FIG. 14 utilizes a connecting stitch 61 of fiberglass, absorbent thread-or other thread through the top absorbing layer 15 and through the non-absorbing layer 2 and back into the absorbing layer 15 throughout the weave so that the non-absorbing layer 2 and at least one of the absorbing layers 15 are permanently stitched together in alignment.

As can best be seen by reference to FIGS. 14 and 15 the lay up comprises a plurality of connecting stitches 61 woven between the top absorbent layer 15 (comprised of a weave or stitching of first threads 62 and perpendicular threads 63) and the non-absorbent layer 2 (comprised of a weave of stitches here first threads 56, an 2 sets of perpendicular threads (for greater sized passages 3) 52 and 53 as shown in FIG. 14). This serves to align the absorbent layer 15 with the non-absorbent layer 2 and also assists in bonding the two layers together. In the present invention, there would be no more than one stitch 61 for every 10 or more stitches of non-absorbent thread to prevent the absorbent connecting stitch 61 from clogging the non-absorbent layer 4.

The threading to tie the layers together can tie absorbent layers above and below a non-absorbent layer with a single thread 61 or may thread the two together using more than one separate thread.

During the process of weaving this member throughout the absorbing weave it is also woven through openings in the weave into the non-absorbing weave and out through openings in the weave coming back up to the absorbing layer and then going back in to the absorbing layer. In this way the non-absorbing layer and the absorbing layer are woven together to make a single sheet along the length of the non-absorbing layer.

The degree of tension and the number of the connecting stitch 61 governs how closely the top absorbing layer 15 is held to the non absorbing layer 4.

The primary improvement in this embodiment lies in the ability to properly align a piece of fiberglass and also to enhance bonding over the non-absorbing layer in much the same fashion as is accomplished with the cut out squares described above.

The utilization of cut out sections 42 as shown in FIG. 5 accomplishes much of this result but this improvement allows for varying degrees of alignment, tension and binding which are not as easily accomplished with the embodiment shown-in FIG. 5. The embodiment in FIGS. 14 and 15 allow for the ease of set up or the ease of alignment of the absorbing layer to the non-absorbing layer which is important in order to have a smooth and consistent interface and in order to prevent the non-absorbing layer from being too thick and to provide bunching up the reenforcing material.

As can best be seen by reference to FIG. 14 connecting stitch 61 woven between a top layer of absorbing material 65 and a bottom non-absorbing layer hold the two permanently together.

As can best be seen by reference to FIG. 16 (where the non-absorbent layer 2 is distinguished with cross-hatching) this technology can also be used in order to create sheets 67 of non-absorbent layers 2 stitched together with absorbent layers 15.

The arrangement of these sheets 67 may help disburse resin. As shown in FIG. 17, a top sheet 67 feeds resin to middle absorbent layers 20. At the bottom, to allow for the resin to be properly distributed there are two layers, one inverted relative to the other, of this stitched absorbing and non-absorbing material in sheets 67 to provide a greater degree of resin disbursing.

This increases the width of the non-absorbing layer where two layers of non-absorbing weave 66 face each other.

One benefit would be to allow the outflow of resin which was thickened at the bottom of a mold by having a greater area of non-absorbing material at the bottom by having more non-absorbing surface area while at the top, less surface area is necessary for the resin which did not have to pass through absorbing material.

As can best be seen by reference to FIG. 16 each sheet of combination material has at least one top layer 15 which is made of absorbing material and a bottom layer 4 which is made of non-absorbing weave.

The top layer and the bottom layer are held together by connecting stitch 61.

Improvements of the present invention over the prior art lie primarily in the technique of stitching the layers together in order to create pre-made sheets of absorbing and non-absorbing layers. The benefit of this is that given a sufficient weave along a sufficient amount of area, a cloth utilizable in the process described herein can be more easily laid out.

While the strands of the stitch 61 are preferably resin absorbing to hold the absorbing layers more tightly to the non-absorbing layers, if this was unnecessary, as where cut-outs were used, the strands could be non-resin absorbing or could alternate between absorbing and non-absorbing strands.

It can be seen then that the invention involves the use of absorbing or non-absorbing threads in order to hold together layers of absorbing material with layers of non-absorbing material. The lay-up is comprised of absorbing layers on either side of at least of the at least one non-absorbing layer 2. Another embodiment would involve the use of either non-absorbing threads or absorbing threads in order to hold the layers together or a combination of absorbing threads and non-absorbing threads in order to maintain the contact between the lay-up comprised of absorbing and non-absorbing materials threaded together with a particular emphasis on the function of allowing the non-absorbing layer to carry resin throughout the mold when sandwiched between two absorbing layers and held by the connecting thread 61.

The more area where an absorbing thread or a non-absorbing thread connects the layers together, the better the alignment. Also, absorbing threads and non-absorbing threads may be utilized together so that the absorbing and non-absorbing layers are held tightly or along a great surface area, but sufficient non-absorbing passages 3 remain in the non-absorbing layer 2 so that the non-absorbing layer 2 can continue to carry resin throughout the area of contact with the absorbing layers 4 and 15. Hence, it may make sense to talk in terms of the number of absorbing threads holding the non-absorbing layer and the absorbing layer together per square inch or per square foot of material, and also to talk about the number of non-absorbing threads per square inch or per square foot of material in order to determine the amount of resin carrying available in the non-absorbing layer 2. It also can be seen from this discussion that as the thickness of the mesh or the number of layers of mesh in the non-absorbing layer increases the number of absorbing threads 61 which may be used while still maintaining the resin carrying characteristics.

It can be seen then that the invention involves at least two elements: (1) The element of using absorbing or non-absorbing threads in order to hold together layers of absorbing material with layers of non-absorbing material and preferably a layout comprised of absorbing layers on either side of at least of one non-absorbing layer. (2) The second invention would involve the use of either non-absorbing threads or absorbing threads in order to hold the layers together or a combination of absorbing threads and non-absorbing threads in order to maintain the contact between the layout comprised of absorbing and non-absorbing materials threaded together with a particular emphasis on the function of allowing the non-absorbing layer to carry resin throughout the mold when sandwiched between two absorbing layers.

Since there are many variables in how much absorbing thread could be utilized in order to hold the layers together, it is significant to look at it in light of the desired function and to quantify it by the amount of absorbing thread per given area, the thickness of the non-absorbing layer, the width of channels formed by the non-absorbing weave, the size of the mold, the number of inlets and outlets where vacuum or pressure is utilized. And it should be noted that usually a vacuum would be necessary in order to make sure that the non-absorbing layer functions to pull resin through the mold and to prevent air from leaking into the non-absorbing layer from either of the absorbing layers.

Threading provides a substantial improvement over other novel embodiments which might include the use of glues, patches, tape or other adjoining means because the thread is more easily incorporated into the mold. To the extent these types of joining means could better mimic the function of thread and could be as easily used to form the composite structure of resin absorbent and non absorbent materials, they might be substituted in whole or in part.

Referring to FIG. 18, it can be seen that by using this method in conjunction with other techniques, a unique finish is possible for fiberglass lay ups. In addition, modifications to cores are possible.

In the embodiment shown in FIG. 18, a clear coat of gel coat 75 is placed against the mold bottom 19. The next layer is a first bottom reinforcing layer 76a above which is a bottom non-absorbing mesh layer 2a which is between the first bottom reinforcing layer 76a and the second bottom reinforcing layer 76b which defines a bottom non absorbent passage 15b which, in this embodiment, has a tube 14b providing resin though an inlet 78 which is sealed with a self sealing nut 77.

The first bottom reinforcing layer 76a may be a clear resin absorbing layer, but it is preferably a first printed layer, durable enough to withstand the resin impregnation process. The the second bottom reinforcing layer 76b is also preferably imprinted.

As an alternative, if the resin absorbing layers cure clear, then the next layer is a bottom non-absorbing mesh imprinted with a non-resin solvent dye which carries the pattern, color or sign desired.

In order to provide for a proper finish, these layers are against a flat or smooth (for curving shapes) solid core 40. The core 40 may be solid since the resin is carried by the non-absorbing layer 15 and may be carried to those cores by tube 14(b).

The opposite side of the mold may be laid up in the reverse order. In this case, the layer on top of the core 40 is a second 5b and third 5c resin absorbing layer followed by the FLOW CORE non-absorbing layer 2. Next is the top absorbing layer 5a, cut to form openings 15 to allow resin to flow through the resin inlet ports when a vacuum is applied to the vacuum ports and into the flow core via distribution vacuum perimeter 17. A top gel coat layer 75b on the top may be used where it does not interfere with the openings 15 through the top absorbing layer Sa. In conjunction with the other disclosure the number of absorbing layers on top may vary from one to any number where the mold function is not compromised. The bottom layers 5b and 5c may be eliminated as shown in other embodiments where the non-absorbing layer 2 is next to the core 40.

The two colors or patterns embedded in layers 5a and 76b may be different for the bottom layer and a top layer in order to give a unique colors or instructions.

This mold is like the molds described previously and has similar gasket seals 26, a mold top 18 and a mold bottom 19, and resin output tubes 24a and 24b as well as multiple inlet tubes 14a and 14b. One or more inlet tube 14b goes to the lower non-absorbing mesh 2a. The other inlet tubes 14a go to the mold top and preferably at least one would go through a passage 15 to the non-absorbing layer 2. Here, all of the inlet tubes 14a move through passages 15 to go the non-absorbing layer 2.

In order to accomplish this, it is necessary to have the fiber absorbing material in the top layer and bottom layer 5a and 76b respectively have an adequate amount of binding and also that all of the dyes and colors either be resistant to fiberglass resins or react with fiberglass resins to give the desired result.

As can be seen by reference to FIGS. 18, 21 and 22 reinforcement within a mold may be added by providing a mold having an inlet 7 for receiving resin and providing in the mold a passage 82 in the top of the mold continuous with the resin inlet 7 and forming a ridge on the mold extending from the inlet toward at least one edge of the mold (going to four edges in FIG. 22). Since fiberglass resins alone usually make poor reinforcement, a reinforcing member 83a or 83b in FIG. 18, may be added. This reinforcing member may be continuous with the layup so as to form reinforcing member within the ridge when resin is added.

For purposes of clarity, FIG. 21 identifies the layup 86 as a block within the mold bottom 19.

Preferably this reinforcing member is porous and the ridge is attached by way of at least one thread 61 running through or over the reinforcing member and through or under at least the first layer of reinforcing layer 5a below the reinforcing member 83b.

The one thread may be a plurality of threads. The reinforcing member 83a is comprised of a matting; here rolled matting. It may also be layered matting with a resin non-absorbent layer included.

If the, matting is a non-resin absorbent weave it may help distribute resin.

If it is resin absorbing, it add strength.

As shown in these figures, where a pipe of non-resin absorbing material is used for the reinforcement 83b, this pipe may have openings 85 and be continuous with the non-absorbing layer at least at one point along the length by way of at least one opening 85 formed in the top layer 15 to help distribute resin.

Since, consistent with this patent, the reinforcing member 83a may be formed of resin absorbing layers and resin non-absorbing layers which may be stitched together, it may be constructed in accord with the techniques set out herein.

In one embodiment a camouflage material is utilized in conjunction with the top and bottom layer in order to produce a shell which is permanently camouflaged in the color and pattern desired.

The prior art allows for a colored gel coat but it has not been the case that cloth with designs or color could be utilized in conjunction with fiberglass because of problems with finishes using prior art techniques.

One of the reasons for this is that utilizing historical techniques has been very difficult in order to have the materials smooth against the gel coat.

It is possible that the top non-absorbent layer 2 would also be impregnated with a non resin soluble dye in order to have a separate pattern.

These patterns may include instructions where the finished product requires warnings or instructions. These may be permanently within the fiberglass lay up.

Another benefit of this technique is to have interior cores 40 which may be used as solid cores with this process and include materials for:
sound proofing, sound absorption, heat proofing, vibration damping, or heat absorption (Balsa, close cell foams, high density foams, etc.) as well as exterior decorations, camouflage (resin non-solvent dyes in the absorbing or non-absorbing layers), radar absorption, radio wave absorption, etc.

As can best be seen by reference to FIG. 18, the technology embodied herein allows for significant improvements in the construction of different products by allowing a method of even distribution of fiberglass over a pattern or sign or picture or specialized materials.

Prior Art technologies have not allowed for the design to be evenly distributed to be encased in gelcoat in an acceptably visible manner. This is particularly true when two sides require a pattern or sign.

The present invention allows artistic displays within the fiberglass resin and also allows for instructional information to be displayed within a fiberglass lay up.

Structural integrity can be enhanced through reinforcing panels (cores 40) within the fiberglass layup matrix.

A durable resin absorbing layer or non-resin absorbing layer being imprinted with a resin resistant dye is essential in most embodiments. In most situations a thin layer of resin absorbent material which is transparent upon curing may be in place between the imprinted layer and the gelcoat which is also clear. Next are additional non-patterned resin absorbent layers in the number desired and a knitted layer of non resin absorbent materials in the form of a weave defining channels through which the resin may be distributed from the resin inlet throughout the mold.

As shown in FIG. 23, the core 40 may be perforated to define holes 33b in order to allow the resin to flow from a top resin distributing non-absorbing mesh 2 to a bottom distributing non-absorbing mesh 2a.

FIG. 24 shows yet another embodiment where there are top inlet 78 and vacuum fittings 78a and bottom inlet 78b and vacuum fittings 78c to distribute resin to the top and bottom of the core 40.

This is followed by at least one layer of resin absorbent material and finally the top of the mold is put in place which is typically also coated with gelcoat in order to provide a finish, to the product.

As can best be seen by reference FIG. 19, the reinforcing channels 81 formed in this type of mold yield, as shown in FIG. 20 a ridge which would either be sanded down or, preferably be curved to act as reinforcement.

Referring to FIG. 20, the final product when the layup is poured includes an outside finished surface which may have any pattern which is desirable. A camouflage pattern may be on the outside surface and an instructional information on the inside surface. In addition, the inside surface defines reinforcing ridges 80 which ensures the strength of the form.

The reinforcing ridges 80 if they include inserts 83 may have inserts which are made of rolled resin absorbing material or folded resin absorbent materials in order to provide for continuity of the reinforcing material and in order to provide different structural features to the final product. These inserts 83 may be stitched to the absorbing and non-absorbing layers in the mold.

Either the cores or the external resin absorbent materials may use dyes or materials which enhance any number of features of the final product.

To further reinforce this, there maybe reinforcing member 83 embedded within the fiberglass ridge. This member 83 may be absorbing mesh or roll of absorbing mesh, or even a rod comprised of either nonabsorbent material. If non-absorbent, this member 83 may be a mesh in which case it could carry resin. It could be a combination, stitched or not of non-absorbent mesh and absorbent material. If not solid, it could be stitched to the other non-absorbing or absorbing layers (here 5a, 5b, 2, 4a and 4b).

In the embodiment shown in FIG. 19, the resin flows through inlet tube 14a which is held in place by self sealing nut 69 within a bolt having a head 84. This tube 14a pierces a silicone vacuum bag 47 to provide a seal in place of a mold with vacuum gaskets and a layer of peel ply 48 to give a smooth finish. The top 18 defines reinforcing channels 81 extending outward from the resin inlet raised above the regular level of the mold. Re-enforcing members 83 may extend within these top channels as described above.

In FIG. 22 the resin inlet 7 is shown at the center of the mold with reinforcing channels 81 being formed outward in multiple directions by raised mold areas 82.

The reinforcing members 83 in these examples are against the top layer 5a of resin absorbent material of the layup and are below the top gelcoat layer if one is used except where the gel coat is broken for openings for resin to pass within the mold.

FIG. 26 shows where a vacuum bag 47 replaces the seal 26. A resin input tube 1 fits through a input opening 7. The opening is secured by a polypropylene low pressure tube fitting comprised of a raised hollow bolt 30 which bolt has, mid way, a fixed nut 31 which can receive a wrench to allow this bolt 30 to be tightened over a washer 32 which washer 32 compresses and forms a seal with a rubber gasket 79. To hold the bag 47 in place and hold the bolt to the mold, the bottom of the bolt is held by a bottom flat nut 70 which is shown in more detail in FIG. 27 from a bottom view.

A self sealing nut 77 of the type previously described holds the tube.

As shown in FIG. 27, the nut 70 defines a central depression in which the bottom of the bolt 30 can be seen. From this central depression 70b, channels 70a may extend to assist in the distribution of resin to either side of this fitting.

In this embodiment, an identical arrangement is used on the bottom of-the mold to provide a vacuum, except there need be no opening 15 and the size of the parts may be smaller and the nut 70 need not define distribution channels 70a and 70b.

Lighted Panels:

FIG. 28 shows how the holding layer 71 (usually a nonabsorbent layer) receive fiber optics from tube 93, tube 93 may fully encase the fibers or may end, as shown here after entering the mold or lay up. The tube fully containing the fiber optics (FIG. 35) could be made of clear resin with out pressure or vacuum to protect the fibers. The tube may be of any shape and width and length consistent with the size of the lay up. The tube 93 may be hollow or partially or fully filled with resin or other cushioning materials surrounding the fiber optic fibers to protect the optics. Resin may be fed from the side feed 72 as well as the top tube 1.

With a side feed 72, all of the interfering layers are cut away and the path of least resistance becomes the path through the side opening 73 thereby provided and through the nonabsorbent center (here holding layer 71) and the resin may then move further through the non-absorbent layers 3 and 4.

In order to enhance movement of the Resin, a irregularly surfaced flexible peel ply layer 74 may be utilized to help form the outer shell of the lay up, along with a vacuum bag 85.

This irregularly shaped flexible outer peel ply layer 74 may be a collapsing outer layer to form a flat surface or may maintain all or part of its irregular surface shape in order to provide a textured surface to the outside of the lay up.

However, if used in conjunction with peel ply, a flat surface to the outside of the piece being made, may be created even if the irregular surface does not collapse and flatten out under the vacuum.

The mold is eliminated or supplemented with a vacuum bag. The shape of the panel may be controlled by shaping the piece against the mold before or after the application of resin and before the resin is cured. Where a normal mold was used, this would allow that the mold would not need to be vacuum sealed.

Here, a top and bottom outer non-absorbent layer 86 and 87 are used.

In one embodiment of the invention, between or within the gel coat layer in a core, a light means 88 may be inserted. At least one of the top layers 5 or bottom layers 4 may be an imprinted layer bearing a print. The powered light means (here fiber optics 89) lighted by a power source means inserted or out of the lay up (here powered light bulb means 90). The fiber optics 89 here terminate within the lay up or, as shown in FIG. 29 within a holding layer 71 which may after application of resin, be a clear reinforcing layer or behind a semi-opaque reinforcing layer. These fiber optics 89 may be embedded within the resin and weave of any layer.

For example, to hold the fiber optics in specific locations, a layer such as core 40 in FIG. 6 may have the fibers come through one or more of the openings 33a or 33b which allows for the optics to be placed through specific openings provided therefor in a layer of mesh or solid material within the lay up.

In the embodiment shown in FIG. 28, there is a tube 93 protecting the strands of glass as they pass into the mold so that the application of the vacuum does not break the glass.

The optics 89 light up a tube 71a which may be made of reflective material (opaque or clear with reflective flecks or flourescent) so that the tube 71a is illuminated by the light coming into it thereby lighting the panel.

A larger intermediary tube 68 is shown in FIG. 28 which carries light to the individual array of lights. While tube 68 is shown outside of the layup, it may pass through or be used in place of the tube 93 in which case the fiber optics 89 would begin within the layup or within the layer 71 described in FIGS. 32-34 in different views. While the threads 105 and 106 appear to end before reaching the tube 93, in practice they would encase the tube 93 and these same threads could encase a tube 71 a where that type of arrangement was utilized to light the completed panel.

In one embodiment, shown in FIG. 29, the light bulb 90 could be powered from solar panels 92 and accompanying batteries 91 adjacent to a surface and protected in the clear resin matrix 93 allowing access to sunlight. The layers 3 and 4 are not shown in the completed panel shown in FIG. 29, but they would be above and below the holding layer if desired.

The lights could also work as either, powered lights (FIG. 35) as with. LED lights 100 [as opposed to fiber optic lights from fiber optics running off of powered lights]. In the event that the powering system was not embedded within the fiberglass matrix, the wires 99 or fiber optics 89 which feed lights 99 would lead out of the lay up.

Fiber optics could go out of the panel at any point in the lay up to a power source of any type known in the prior art. FIG. 35 shows a prefabricated insert 101 instead of lights within an unsaturated weave as shown in FIG. 34.

Preferably the fiber optics would run into the lay up through a reinforced tube 93 sealed around the fiber optics.89 and strong enough to prevent crushing the fiber optics as resin is injected. The tube 93 could be filled with putty or hardened resin around the optics 89 to prevent the resin in the lay up from leaking out as the lay up is treated with resin.

In the event of moving parts, tires for example, the power source could be mounted to the moving part or by lights shining across a gap into the moving parts and in the case of non-moving parts, the power could be fed through wires.

One example of how this would work would be to have fiberoptic displays from a single light source into multiple panels about a vehicle as shown in FIG. 30.

This would provide that brake lights 94 and front lights 95 (or fog lights and or backing lights) could all be powered by a single location 96 with those lights going through those panels carrying the fiber optics in order to provide light. Passage from the single location can be allowed or stopped by controlling the light source mechanically shutting off light or powering LED lights from processors 104 which power LED lights to light the panels or allow or block light from light sources like bulbs 90a and 90b.

This would simplify the replacement of burned out bulbs 90a and 90b, and the system could be designed with a certain level of redundancy so that one bulb 90a burning out would not destroy the entire system, but would instead just go to a back up light bulb 90b until such time as the primary source of light could be replaced.

In addition, this could be utilized in order to have various light displays 97 for decorative purposes on a vehicle 98.

Another special case is where a light 102 is provided which provides light into optic openings 103 around a wheel which sequentially receive light from the light 102 to display the top 3 of the optics 89c.

In one embodiment, the lights could be a part of the weave of the non-absorbent layer although they could also be woven through a clear or semi-opaque absorbent layer of material as an alternate embodiment.

By having single or multiple layers of material, and having single or multiple layers of fiber optics interspersed with the layers of material, it is possible to get different colors and effects. This may also be accomplished by having different color light feeds (e.g. different colored bulbs 90a and 90b) into a fiberoptic network with or without reflection material woven above, below or adjacent to the lights.

Referring to FIG. 34, a lay up may have horizontal reflective threads 105 and non-reflecting threads 106 on either side, above or below fiber optics 89 (or LED lights in place with the optics 89) and vertically woven threads (reflective 107 or non-reflective 108) woven with the horizontal threads. Tube 93 is shown going through a mold wall 109 with a plug 110 with material to cushion the fibers 89.

The reach of the threads 105-107 could go to the edges of the lay up or be concentrated in the center for any of the 4 thread types.

FIG. 33 is a detailed view of the fiber optics 90 coming into the holding layer 71. FIG. 32 is a top view of 33 from the 32-32 axis showing how the ends 89a of each of the fiber optic threads 89b of the fiber optics 89 point outward at whatever angle 89c they point up towards the top 71a or bottom 71b of the holding layer 71 in order to impart light to the panel.

While in FIG. 33 all of the ends 89a of the individual fibers 89b point towards the top 71a of the holding layer 1 in fact, they may also point towards sides top or bottom of that layer in order to make sure that the panel glows through any and all different directions. The ends 89a pointing up may have different colors than those pointing to the sides or down to give different effects.

It should be noted that the number of fiber optics within the holding layer 71, which holding layer 71 may actually be multiple holding layers 71 located at different locations through out the panel, may be fed from one or more incoming fiber optic panels or one or more light sources either within or without the panel.

Referring to FIG. 32 it is seen that there are 7 columns across the three rows in each column down. This type of even spacing is not required but made possible by embedding these in a matrix 71 which matrix 71 may either be rigid or flexible and it is preferably a weave.

The more rigidly it is constructed the more easily the individual ends 89a maybe aligned.

Likewise each of the fiber optics ends 89a may display one or more different lights by being fed through one or more different light sources in order to provide the type of color variations as seen in other systems such as televisions where multi light colors are combined in order to yield a picture.

While in the example shown in FIG. 32, there are only 21 different ends 29a in fact there could be any number of these by either increasing or decreasing the size and number of fiber optics.

Also while fiber optics are taught in the preferred embodiment, other screens or LED lights embedded (light generating means such as a flat screen) could easily be embedded in the resin utilizing the same technology taught herein although those would be different embodiments and would not necessarily be the same inventive concept.

In one example, certain materials can change color in the presence of electromagnetic media, and this technology teaches one method wherein that type of electromagnetically alterable media may be protected within a clear fiberglass resin utilizing the methods taught herein.

In one embodiment, either one of the absorbing meshes or non-absorbing meshes, may be made of a reflective material with varying lengths of fiberoptic running through it so that where the fiber optics ends it sends out a beam of light which is reflected by the reflective material which may be either woven around it or below it in order to create a reflective surface to generate more light outward.

These strands may be further protected within the mold by having them run between layers of material defined as clear structural material which clear structural material hardens without interfering with the passage of light when the resin is added to the matrix.

Hence, one improvement of the invention is to create a mold which allows for a resin to pass within the mold under a vacuum so that a flat layer may be generated of sufficient density while protecting light carrying strands of glass or similar material throughout the mold in order to allow that a light source outside of the fiberglass piece mold may light the ends of the glass strands within the final product.

In terms of a process, this may be described as applying fiber optics to a fiberglass resin lay up.

Protecting the fiber optics from impact due to the application of resin to the lay up especially at at least one fiber entry point;

Sealing the lay up around the at least one entry point;

Applying resin through at least one resin inlet into the lay up.

The additional step may be included for disbursing the glass fibers of the fiber optics within the mold sufficiently in order to light the panel so that a lit panel is described.

Another step would be to have at least a portion of the fiber optics outside of the mold through an entry point where the optics are protected at the entry point.

FIG. 36 shows the use of multiple fiber optic holding layers 71 and 101 in a single lay up. The way of lighting the optics is variable. The layers maybe fed from different color bulbs or have different type lighting (here 101 shows both fiber optics and led lights and 71 uses optics). The optics are also shown here at different levels and in different layers of mesh.

Because the invention teaches methods for making two faced materials having a front face and a rear face, both of which may be identical, and both which may have facings, it is clear that certain superior technologies may be utilized so that the lighting may light two different sides in two different manners based on the types of materials utilized at each stage.

The fiber optics maybe replaced with flourescent fibers which light up in response to an exterior light source. While the mold for most of the lay ups herein described is comprised of a flexible vacuum bag, it may be supplemented with or replaced with a harder shaped mold 6 as shown in FIG. 36.

FIG. 36 also shows the use of reflective flakes 121 within the lay up to distribute light and the use of cushioning material 120 within the tube 93 to protect the fibers of the fiber optics.

While not shown in every embodiment, it is intended that where the fiber optics are used with a resin non-absorbent weave, the weave can be used as previously described to assist resin in moving throughout a lay up containing resin absorbing threads as is previously taught.

Because many varying and different embodiments may be made within the scope of the inventive concept herein taught and because many modifications may be made in the embodiment(s) herein detailed in accordance with the descriptive requirements of the law, it is to be understood that the details herein are to be interpreted as illustrative and not in a limiting sense.

1) A lay up for producing a lighted panel comprising:
a) a lay up comprised of a plurality of layers of resin absorbing fibers;
b) light generating means for lighting the panel between the plurality of layers of resin absorbing fibers;
c) a layer means within the lay up for holding (binding) the light generating means in place within the plurality of layers.

2) The lay up of claim 1 wherein the light generating means further comprises a power means for generating power for the light generating means.

3) The lay up of claim 2 wherein the power means further comprises a power means external to the layup.

4. The lay up of claim 1 wherein the layer means further comprises a binding means for binding the light generating means to the lay up.

5) The lay up of claim 4 wherein the layer means further comprises a porous layer of material containing the light generating means.

6) The lay up of claim 5 wherein the porous layer comprises a perforated core containing channels for receiving resin.

7) The lay up of claim 6 wherein the light generating means comprises sections and wherein the porous layer comprises a weave interwoven around at least one of the sections of the light generating means.

8) The lay up of claim 6 wherein the light means comprises a light from the group consisting of led lights, fiber optic fibers, blubs in the fixtures or combinations thereof wires terminating in led lights.

9) The lay up of claim 6 wherein the light means further comprises reflective material interspersed with the light means.

10) The lay up of claim 9 wherein the reflective material comprises a material from the group of reflective strips, reflective flakes, flourescent material, threads of reflective material and threads of reflective material, threads of reflective material woven in with a weave interwoven around at least one of the sections of the light generating means and combinations therof.

11) The lay up of claim 2 wherein the power means is embedded within the layup

12) The lay up of claim 11 wherein the power means is a solar power means for generating power in response to external light.

13) The lay up of claim 1 wherein the power means is a power generator external to the lay up and feeding through to the light generating means through a cable means for carrying power from the external power generator into the lay up.

14) The lay of up of claim 13 wherein the light generating means comprise fiber optics and wherein the power means comprises a light generating means and wherein the cable means comprises at least one fiber optic fiber light generating means to the fiber optics.

15) The lay up of claim 13 wherein the at least one fiber optic fiber is protected by a tube means for surrounding the at least one fiber optic fiber which is more durable then the at least one fiber optic fiber said tube means passing from the outside of the lay up into the lay up.

16) The lay up of claim 15 wherein the tube means is filled with cushioning material.

17) The lay up of claim 6 wherein the porous layer is comprised of resin non-absorbing material.

18) The lay up of claim 6 wherein the porous layer is comprised of resin absorbing material.

19) The lay up of claim 1 wherein the light generating means is below a patterned layer.

20) A method for producing a lit panel comprising the steps of:
a) laying out lights in a determined number and arrangement;
b) securing the position of the lights
c) pouring a clear sealant around the lights.

21) The method of claim 20 wherein the step of securing the position of the lights includes the step of securing the lights within a weave.
